(19) United States
(12) Patent Application Publication
(10) Pub. No.: US 2015/0146946 A1
(43) Pub. Date: May 28, 2015

(54) OVERLAY AND REGISTRATION OF PREOPERATIVE DATA ON LIVE VIDEO USING A PORTABLE DEVICE

(71) Applicant: KONINKLIJKE PHILIPS N.V., EINDHOVEN (NL)

(72) Inventors: Haytham Elhawary, New York, NY (US); Aleksandra Popovic, New York, NY (US)

(73) Assignee: KONINKLIJKE PJILIPS N.V., EINDHOVEN (NL)

(21) Appl. No.: 14/402,436

(22) PCT Filed: Jun. 28, 2013
(86) PCT No.: PCT/IB2013/055329

§ 371 Date: Nov. 20, 2014

Related U.S. Application Data
(60) Provisional application No. 61/665,329, filed on Jun. 28, 2012.

(51) Int. Cl. G06T 7/00; G06T 19/20; G06K 9/00; G06T 19/00

(52) U.S. Cl. CPC G06T 7/0012; G06T 19/00; G06T 19/20; G06K 9/00624; G06T 2207/30048
USPC 382/128

(57) ABSTRACT

A medical imaging system includes a computer device including a processor (114) and a memory (116) coupled to the processor. The memory stores recorded anatomical images (130) of a subject and a registration module (142) configured to align the recorded anatomical images with real-time images. A portable video display device (132) includes a camera (136) and a display screen (133). The portable video display device is configured to collect real-time images (134) of the subject to be registered with the recorded anatomical images of the subject such that a portion of the recorded anatomical images are concurrently displayed on the portable video display device registered with the real-time images. A communication link (140) is configured to permit communication and data transfer between the computer device and the portable video display device.

This disclosure relates to medical instruments and more particularly to registering recorded images with live video using a portable video display device.

Coronary artery bypass grafting (CABG) is a surgical procedure for revascularization of obstructed coronary arteries. In conventional surgery, the patient's sternum is opened and the heart is fully exposed. A cardiopulmonary bypass machine is often used so that the heart can be immobilized, making grafting easier. Off pump procedures with the heart beating and stabilized with mechanical structures in a local area around a stenosis have been performed successfully. In open surgery, arteries are usually in part or entirely covered with fibrous-fatty tissue. These arteries can be invisible due to this fatty tissue layer or because they run inside the myocardium. The fibrous-fatty tissue poses a challenge to surgeons to find a correct area to perform anastomosis. Surgeons can palpate the heart surface and feel both blood pulsating from the arteries and stenosis (narrowing of the blood vessel, e.g. due to calcification). However, this data is sparse and might not be sufficient to transfer a surgical plan to a surgical site. Therefore, methods to provide registration and overlay of pre-operative imaging in the interventional procedure are needed to allow transfer of pre-operative structures onto the intra-procedural tissue.

Some methods require the use of specialized and expensive hardware that would not normally be used in the operating room for open surgery. For example, an additional tracking system or systems which are usually not present in the operating room may be required. In some instances, the user needs to palpate the heart surface with a special optically tracked instrument to help the surgeon orient and register a pre-operative image to the current open heart structures. In other systems, most of the arteries need to be visible to enable the surgeon to digitize them. Therefore, for open cardiac bypass surgery, it has not been possible to provide registration and overlay of pre-operative imaging data, such as for coronary arteries and a bypass anastomosis site, without the use of expensive additional hardware not normally needed in the operating room. The conventional methods also require tedious tracking and selection of features on the anatomy in addition to complex workflows.

In accordance with the present principles, a medical imaging system includes a computer device including a processor and a memory coupled to the processor. The memory stores recorded anatomical images of a subject and a registration module. The registration module is configured to align the recorded anatomical images with real-time images. A portable video display device includes a camera and a display screen. The portable video display device is configured to collect real-time images of the subject to be registered with the recorded anatomical images of the subject such that a portion of the recorded anatomical images are concurrently displayed on the portable video display device registered with the real-time images. A communication link is configured to permit communication and data transfer between the computer device and the portable video display device.

A portable video display device for medical imaging includes a camera configured to collect real-time video, and a display screen configured to display the real-time video concurrently with overlay images registered with real-time images. A processor and a memory coupled to the processor are included. The memory stores recorded anatomical images of a subject and a registration module configured to align the recorded anatomical images with the real-time images. The overlay images include at least a portion of the stored anatomical images and are displayed on the portable video display device to assist a user in viewing anatomical features not readily observable.

A method for medical imaging includes storing anatomical images of a subject; providing a portable video display device including a camera and a display screen, the portable video display device being configured to collect real-time images of the subject; registering at least a portion of the anatomical images with the real-time images; and concurrently displaying on the portable video display the at least a portion of the anatomical images registered with the real-time images.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

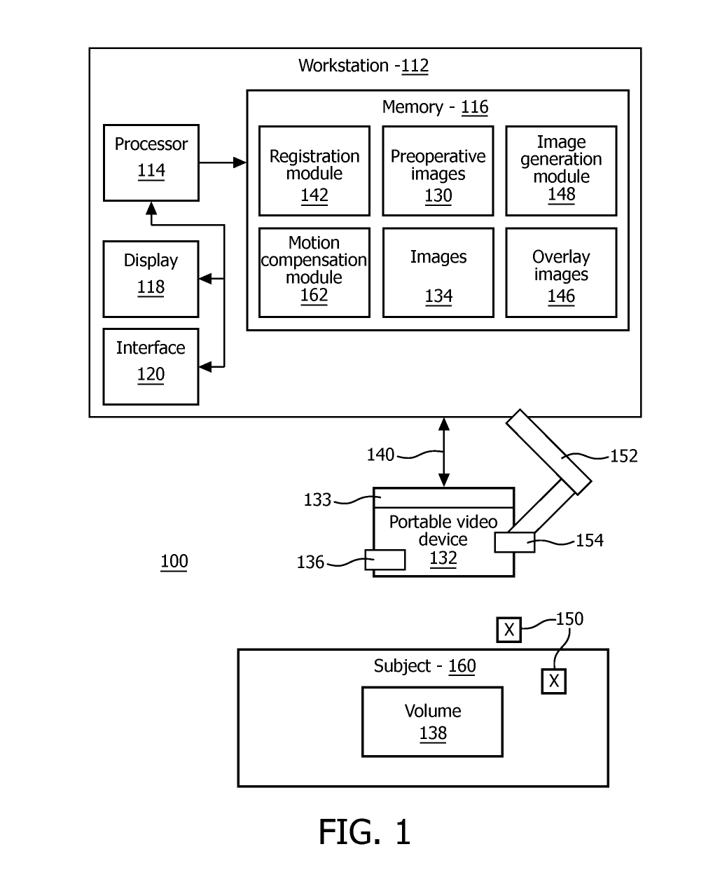

FIG. 1 is a block/flow diagram showing a medical system which employs a portable video display device in accordance with one embodiment;

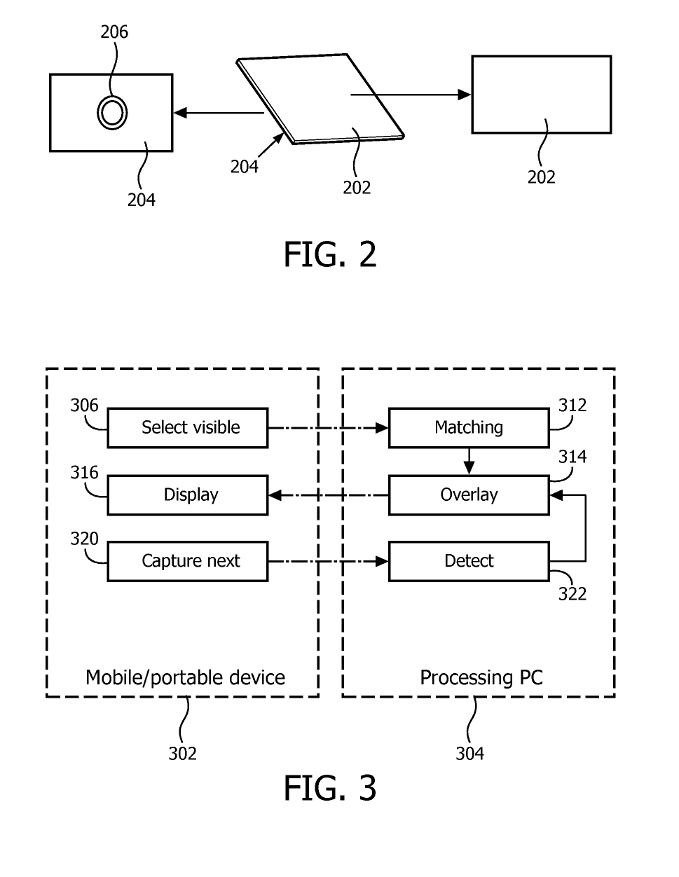

FIG. 2 is a schematic diagram of a portable video display device showing a camera on one side and a display screen on an opposite side in accordance with one embodiment;

FIG. 3 is a block/flow diagram showing interaction or program flow between a portable video display device and a workstation or processing computer in accordance with one embodiment;

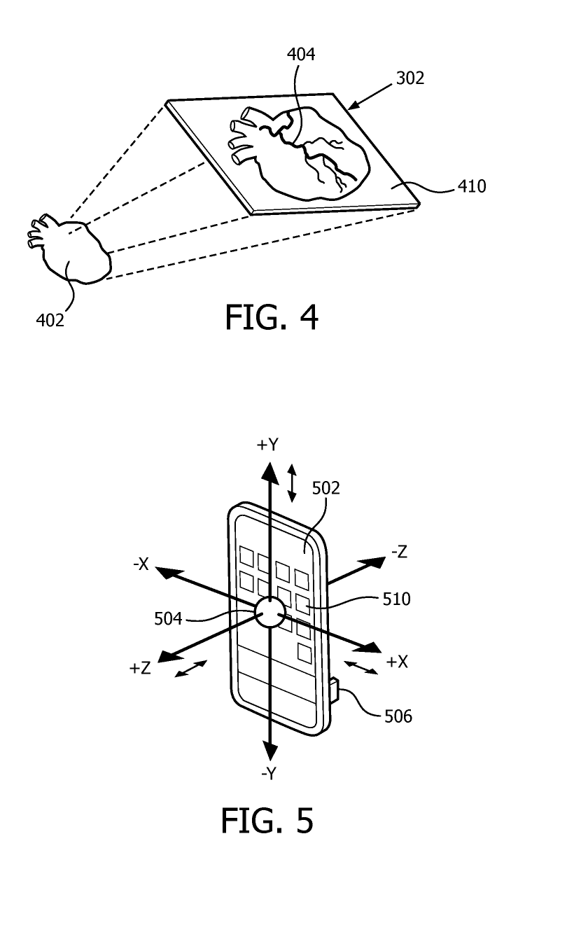

FIG. 4 is a diagram showing a screen of portable video display device showing a real-time image of a heart with an overlay of coronary arteries in accordance with one embodiment;

FIG. 5 is a perspective view of a portable video display device showing a three-dimensional accelerometer (or gyroscope) in accordance with one embodiment;

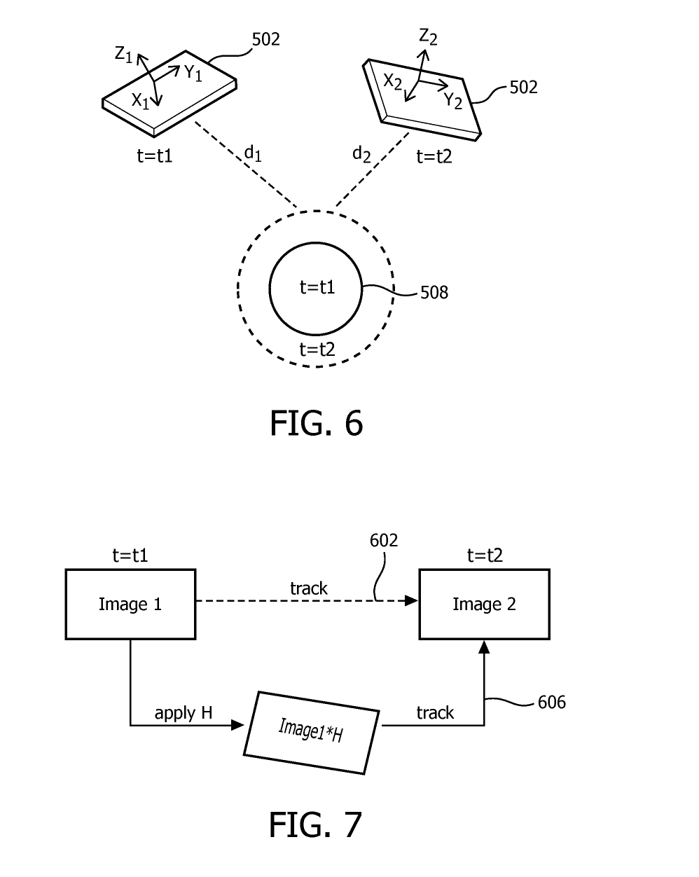

FIG. 6 is a diagram showing a portable video display device and an anatomical feature (e.g., a heart) at two different times indicating two illustrative motions that can be compensated in accordance with one embodiment;

FIG. 7 is a flow diagram showing a method for tracking images using an image homography matrix in accordance with one embodiment;

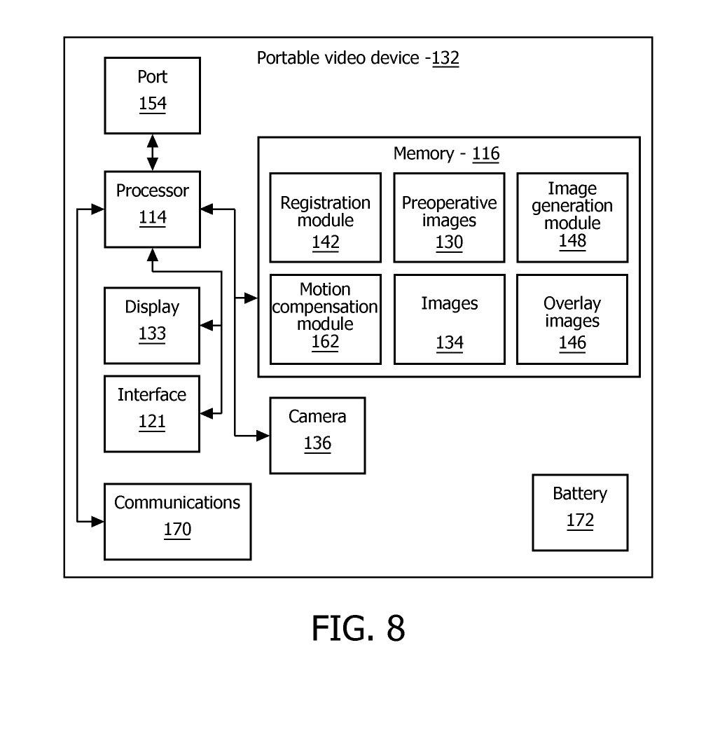

FIG. 8 is a block/flow diagram showing a portable video display device with extended capabilities for performing tasks in accordance with another embodiment; and

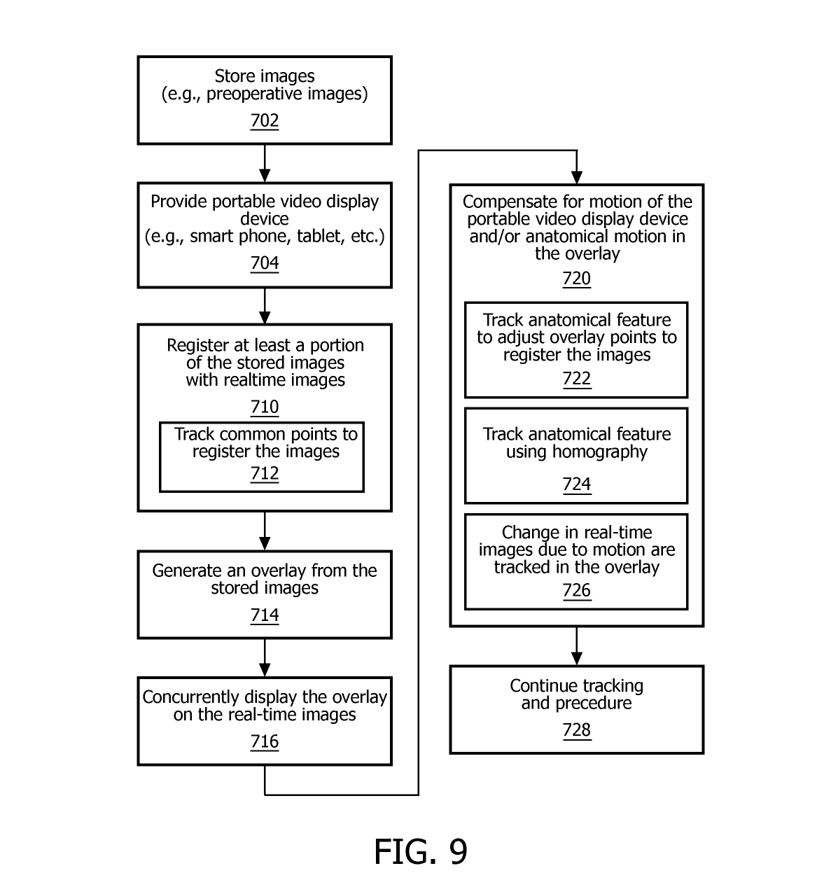

FIG. 9 is a flow diagram showing a method for medical imaging using a portable video display device in accordance with illustrative embodiments.

In accordance with the present principles, systems and methods are provided to perform recorded image registration with a portable video-capable device for preparation for open surgery. In particularly useful embodiments, an inexpensive off-the-shelf tablet computing device or other smart tablet device with computational power may be employed. Examples of such devices may include an APPLE® iPad®, a SAMSUNG® Galaxy® tablet, smart phones, application specific tablets or display devices, etc. The combination of the registration method and a portable video and visualization device provides a system, which permits real-time visualization of internal organs and surfaces (e.g., a heart surface) with overlaid anatomical features (e.g., arteries, an anastomosis site, etc.), which can assist in providing a surgical plan and execution of the plan during a procedure (e.g., open heart coronary bypass surgery).

The system may include a mobile/portable device, such as a tablet personal computer (PC) or smart phone with a screen on a front side (facing the user) and a video camera (or a web camera) on a back side. Optionally, a PC with high processing power and high storage capabilities may be provided for data storage and processing for video and other applications. A digital link, such as a Wi-Fi link, is provided for communication between mobile/portable device and the processing PC. The system includes applications configured and stored on the mobile/portable device and/or the processing PC to generate an overlay image of pre-operative structures onto a video image provided by the portable device. No other hardware or tracking methods are needed. In open surgery, where an endoscope is not available, the overlay of arteries is not possible, making the overlay registration technique unavailable to the surgeon without the use of some external video stream. The present principles provide an effective, inexpensive and simple solution to such issues.

It should be understood that the present invention will be described in terms of medical instruments; however, the teachings of the present invention are much broader and are applicable to any imaging system. In some embodiments, the present principles are employed in tracking or analyzing complex biological or mechanical systems. In particular, the present principles are applicable to tracking and visualization procedures of biological systems, procedures in all areas of the body such as the lungs, circulatory system, pulmonary system, gastro-intestinal tract, excretory organs, etc.

The elements depicted in the FIGS. may be implemented in various combinations of hardware and software and provide functions which may be combined in a single element or multiple elements. The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which may be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), Blu-Ray™ and DVD.

Referring now to the drawings in which like numerals represent the same or similar elements and initially to FIG. 1, a system 100 for visualizing internal structures using a portable video device is illustratively shown in accordance with one embodiment. System 100 may include a workstation or console 112 from which a procedure is supervised and/or managed. Workstation 112 preferably includes one or more processors 114 and memory 116 for storing programs and applications. Memory 116 may store one or more applications for assisting in providing video images for visualizing internal structures. In one embodiment, memory 116 stores preoperative images (or recorded) 130 taken in advance of a procedure for a particular subject 160. The preoperative images 130 provide a 3D image or model of an anatomy to be viewed. Other recorded images of the subject 160 may be employed as well (intra-operative images, etc.).

The system 100 includes one or more mobile/portable video display devices 132. The video display devices 132 may include tablets, smart phones, portable digital display devices, etc. The video display devices 132 may include commercially available devices or may include a specially designed display tablet or device.

A communication system or link 140 can be established between the workstation 112 and the video display devices 132 to permit the transfer of information, commands and data (e.g., images). Communication can be established based upon the capabilities of the video display devices 132. For example, the video display devices 132 may include Wi-Fi capability, cellular communication capability, an internet link, Blu-Tooth™, etc. In one embodiment, the link 140 may include a hard wired connection established between the workstation 112 and the video display devices 132 through a cable or cables. The cable may include fiber optics, electrical connections, other instrumentation, etc., as needed.

In one embodiment, workstation 112 includes an image generation module 148 configured to generate overlays to be displayed on the video display device 132. An image 134 (e.g., a real-time image collected by a camera 136 from device 132) may be transmitted back to the workstation or PC 112 of a space or volume 138, e.g., a chest cavity. The image 134 can be displayed on the video display device(s) 132 and/or a display device 118 of the workstation 112, if available and desired. Workstation 112 may include the display 118 for assisting in setting up the video display devices 132, viewing internal images of the subject (patient) 160 and volume 138 and performing other functions of the workstation 112.

Display 118 may also permit a user to interact with the workstation 112 and its components and functions, or any other element within the system 100. This is further facilitated by an interface 120 which may include a keyboard, mouse, a joystick, a haptic device, or any other peripheral or control to permit user feedback from and interaction with the workstation 112.

In one embodiment, the image 134 will be displayed on the video display device 132 registered with the preoperative images 130 of the subject 160 and/or volume 138 using methods stored in a registration module 142. The registration module 142 may be part of the image processing module 148 or be a stand-alone module. The registration module 142 aligns images using common landmarks, known anatomical features or other image processing techniques. By holding the video display device 132 over the subject (patient) 160, internal anatomical features (e.g. volume 138) can be viewed on a display screen 133 of the video display device 132 without opening up the patient. The display screen 133 shows the real-time images 134 registered with the preoperative images 130 (or portions thereof). Moving the video display device 132 will accordingly change the view of the internal anatomical features (e.g., both the real-time images 134 and the preoperative images 130).

In this embodiment, parts of the internal anatomy can be located using external features to register the preoperative images 130, and the video display device 132 may be employed to display the preoperative images 130 (internal organs and features) registered with the real-time images 134 of the skin (external anatomy) of the subject 160 to mark the patient for surgery, plan incisions or port locations, or provide other functions. The video display device 132 may include a real-time video of the subject 160 (external skin image) and generate a registered overlay 146 of the preoperative images 130 or a portion of the preoperative images (e.g., coronary arteries, heart, etc.). The anatomy of the preoperative images 130 is accurately registered to the real-time video images 134 using landmarks or reference points 150 between the two domains. The reference points 150 may be anatomical features or may include fixed points on an operating table support surface, a fixed arm, etc. Registration to the fixed position may be performed in advance of surgery, and, once registered, the fixed position may be defined in the preoperative image domain and used to register the real-time images 134 for planning, during the procedure, etc. Other registration techniques are also possible and contemplated in accordance with the present principles. Such planning procedures or examinations may be performed in a doctor's office, in the field, or any other location.

The portable video device 132 may be held in position using an optional immobilization arm 152. The arm 152 may be selectively adjustable so that it can be conveniently positioned. The arm 152 may include power or data connections/interfaces 154 and may be configured to permit docking of the portable video device 132 for power charging or data collection (e.g., may be included with link 140).

In particularly useful embodiments, a method to visualize arteries and other structures not directly visible on a heart surface during open heart surgery may be employed. After planning, open heart surgery is performed by opening the chest and exposing the heart. Due to fascia and fatty tissue, the blood vessels in the heart and surrounding areas may not be readily observable. Using a matching algorithm, the shape of the heart or other landmarks may be employed to register the real-time image 134 of the heart collected using the video display device 132 with preoperative images 130 of the heart. The combination of the registration method and the video display device 132 provides real-time visualization of the heart surface with overlaid arteries and an anastomosis site which can help surgeons plan and execute open heart surgery, e.g., coronary bypass surgery.

In particularly useful embodiments, a motion compensation module 162 is included to account for motion of the portable video device 132 and to account for motion of the anatomical feature (e.g., a beating heart). While the real images 134 collected by the portable video device 132 may be secured using the arm 152, the motion of say, the heart, may have an impact of the overlay image 146. The motion compensation module 162 updates or adjusts the overlay images 146 to ensure that registration and accuracy are maintained.

Referring to FIG. 2 with continued reference to FIG. 1, an example of a mobile/portable video display device 132 is shown that may be employed for real-time visualization in accordance with the present principles. A front side 202 of the device 132 is in part or entirely a viewing screen. A back side 204 of device has a camera 206 or a web camera attached thereto which will be positioned facing down toward the patient.

Registration methods are employed for matching and overlay of, e.g., arteries from preoperative 3D imaging modalities (CT, MR, X-ray angiography, etc.) to the camera video. The camera 206 need not be calibrated, and optical properties of the camera 206 are not required to be known (although may be useful), so any camera could potentially be used and interchanged during the procedure. Preferably, due to the large amount of data from 3D imaging and processing requirements for real time operation (the screen preferably updates at least, e.g., at a rate of about 24 Hz for comfortable viewing), image processing algorithms may be performed on a separate processing computer or workstation 112. Final overlay images 146 are streamed to the mobile/portable device 132 from the processing computer or workstation 112 via the digital link 140.

Referring to FIG. 3, an illustrative block/flow diagram showing interaction between a portable video display device 302 (132) and a computer or workstation 304 (112) is shown in accordance with one embodiment. In one example, a user holds the portable device 302 so that, in the camera view, the heart is visible on a screen 410 as depicted in FIG. 4. FIG. 4 shows a heart 402 having an overlaid image of arteries 404 thereon displayed on the portable video display device 302.

The portable device 302 can be held by the user or can be placed on an immobilization arm 152 (FIG. 1) so that its position and orientation are fixed in space. It should be understood that the image processing may be performed entirely on the portable device 302, and the processing computer 304 may not be needed.

In block 306, the user manually selects features in the image using touchscreen or other interface technology. The features may include arteries (or parts of arteries that are visible on the surface). Selected points are sent to the processing computer 304 to perform matching in block 312 and overlay in block 314. Matching in block 312 includes registering features or landmarks in the real-time video with corresponding features or landmarks in the preoperative images. This may be performed using the registration module 142 (FIG. 1). Overlaying in block 314 includes generating an image of the selected feature (e.g., artery). The overlay may include a phantom image or have other effect(s) to enable better or more accurate viewing. This may be performed using the image generation module 148 (FIG. 1).

Overlay images (from block 314) are sent to the portable device 302 and displayed on a display screen 316 overlaid on the camera video. The portable device 302 continues to capture images in block 320 at its native frame rate (e.g., 24 Hz) and sends images to the processing computer 304, which captures the images. The processing computer 304 detects motion of the device (if not immobilized) by one or more methods in block 322. This may be performed using the motion compensation module 162 (FIG. 1). For example, one method may include tracking points on the heart surface (for example, using Lukas-Kanade optical flow, which is known in art) and updating the matching and overlay blocks 312, 314, accordingly. This works particularly well if the heart is not beating and the patient is connected to a cardiopulmonary bypass machine. The processing computer 304 supplies the portable device 302 with overlay images which are shown on the portable device's screen 316.

Another method to update the location of features (e.g., arteries) is to apply motion compensation to the overlay, which is achieved by tracking features on the heart. This method tracks features on the heart and updates the position of the arteries relative to the tracked features using, e.g., homography projections. This method works well for both on-pump (heart not beating and patient on a cardioplumary bypass machine) and for off-pump where the heart is still beating. Other image processing techniques may also be employed. The blocks 320 and 322 may be performed in a continuous loop.

In another embodiment, internal accelerometers and/or global positioning systems (GPS) based systems internal to the smart tablet PC or device 302 may be employed to assist in tracking the positions of the device 302. These will be described in greater detail below. Other methods may be employed to account for patient motion, the beating of the heart or other motion.

Referring to FIG. 5, a portable video display device 502 is schematically shown with a 3-axis gyroscope sensor or a 3-axis accelerometer 504 and a camera sensor 506. These features are available, e.g., on an iPad® from APPLE®, Inc. and other similar devices. A dedicated algorithm 508, stored on the portable video display device 502, for motion compensation on a beating heart can be implemented without the use of complex hardware, such as endoscopes.

After the registration and overlay (312, 314; FIG. 3) are performed, motion compensation is done to update the position of overlaid arteries on the live video captured by the camera and displayed on the screen of the device 502 (302). In one example, motion compensation may include: 1) movement of the camera system 506 and/or movement of a beating heart 508 (FIG. 6) or other structure.

Referring to FIG. 6 with continued reference to FIG. 5, a representation of the motion between two times, t1 and t2 is shown. The motion is comprised of motion of a camera on device 502 and/or a heart 508 beating. The movement of the camera system (and the entire portable device) is a rigid transformation represented by rotation (Rc) and translation (tc). This transformation changes perspective projection of the heart 508 on the image plane. It is known in art that the change can be represented as a 3×3 homography matrix H, defined as:

$$H = {R}_{C} - \frac{{t}_{C} {n}^{T}}{d} ,$$

where n is the normal vector of the image plane and d is distance from the camera to the heart. (T is the transpose operator). Rotation and translation of the portable device (Rc and tc) can be directly measured from the 3-axis gyroscope or a 3-axis accelerometer 504, both provided on the iPad®. The rotation and translation are measured as a transformation from coordinate system x1-y1-z1 at time t1 to coordinate system x2-y2-z2 at time t2.

In general, distance d (e.g., d1 or d2) is not known. However, since the registration between preoperative data and intraoperative live video (e.g., real-time images) from the camera are known, as well as parameters of the iPad® camera system (focal length from camera data sheet), d can be derived using two bifurcation points from the registered data and the known focal length of the camera system. For example,

$$d = {F}_{x} \frac{x}{X} = {F}_{y} \frac{y}{Y} ,$$

where Fx is an effective focal length in the x axis, x is the distance between two bifurcation points in space (measured from 3D data) and X is the distance between two bifurcation points in image space (in pixels). Generally speaking, the data may be noisy, thus, d computed from the x and y axes may differ. To improve accuracy, an average can be taken. To further improve accuracy, a plurality of d values can be measured between different bifurcation points and a mean or median can be taken for the final value of d.

From established d, Rc and tc values, the matrix H can be computed. The matrix H completely describes the motion of camera system 506 and therefore the device 502.

The motion of the heart 508 can be established using a tracking method combined with known homography methods using matrix H. This may include using a feature tracking framework and assuming that an area of the image maintains similar features over time and that the motion of that area is constrained to a ‘window’ in the image (e.g., within an area of maximum displacement). Computation time of the tracking method significantly depends on this search window (more time for larger windows). For a beating heart, the window can be set using a known amount of motion of the heart. If the registration is performed using an iPad®, the search window can be unacceptably high, since the user can move the iPad® too fast (i.e. the motion Rc and tc may be too large to be tracked using the conventional methods). The homography matrix H is computed over time from a target anatomical feature in the anatomical feature being imaged. The matrix H is employed to deform the recorded anatomical images to maintain registration with the real-time images.

Referring to FIG. 7, direct tracking 602 between an image 1 at t=t1 and an image 2 at t=t2 (as described above) cannot be utilized for a real-time update of artery position (the iPad® camera can capture video at about 24 Hz). To maintain a search window of the tracking method at a same size as for the case where the only motion is the heart beating, additional processing of the images is needed in the motion compensation module 162 (FIG. 1). FIG. 7 shows a real-time tracking method 606. Before a standard ‘track’ procedure is called, the image 1 at time t1 is transformed using, e.g., a 3×3 matrix H (derived from the rotation and translation of the camera). The resulting image “H*Image1” accounts for the entire camera motion. Thus, the image features in “Image2” are within a significantly smaller search window from the same features in “H*Image1” as compared to features in “Image1”. Using this framework, updates of the artery positions in live video can be done at a native frame-rate of the iPad® camera system. While illustrative methods have been described, it should be understood that other features and methods may be employed for image processing to provide steady reliable images on a same scale for use related to surgery or other applications.

The present principles are particularly useful for open heart surgery and specifically for coronary artery bypass grafting. However, the present principles can be applied to other organs where surgery is performed on internal anatomical features such as blood vessels or other vasculature type structures, such as, lymph nodes. Used together with other methods for matching 2D and 3D points, the present principles can be used for any type of open and endoscopic surgery where pre-operative overlay onto intra-operative images is useful and relevant for the procedure. A combination of a registration method and a portable video and visualization device provides a system that permits real-time visualization of internal surfaces with overlays which can assist surgeons in planning and executing procedures.

Referring to FIG. 8, the portable video display device 132 (e.g., a smart phone or a tablet) may be employed for medical imaging as an independent unit as described above. This depends on its processing and memory capabilities. In this embodiment, the functions as described with respect to FIG. 1 are applicable with some differences. The camera 136 is configured to collect real-time video and a display screen 133 is configured to display the real-time video concurrently with overlay images 146 registered with real-time images 134. Communication capabilities are present on a communications module 170. The processor 114 and memory 116 are employed to carry out the imaging functions including overlaying stored images over real-time video.

The memory 116 stores recorded anatomical images 140 of the subject, and the registration module 142, image generation module 148 and motion compensation module 162 are all incorporated. The overlay images 146 are generated and displayed on the portable video display device 132 to assist a user in viewing anatomical features not readily observable. The port 154 provides power and permits recharging of a battery 172 or energy source. Data may be exchanged through port 154. An interface 121 includes a keyboard, touchscreen or other interface for programming, loading, executing and employing software applications of the device 132.

Referring to FIG. 9, a method for medical imaging using a portable video display device is shown in accordance with illustrative embodiments. In block 702, anatomical images of a subject are stored in memory. These images may be preoperative image or intra-operative images taken using one or more imaging modalities, such as, e.g., computed tomography (CT), magnetic resonance imaging (MRI), X-ray angiography, etc. In block 704, a portable video display device is provided and includes a camera and a display screen. The portable video display device may include a smart phone, a tablet or other display device. The portable video display device is configured to collect real-time images of the subject.

In block 710, at least a portion of an anatomical image is registered with the real-time images taken by the portable video display device. In block 712, common points are tracked between the anatomical images and the real-time images.

In block 714, an overlay is generated from the stored images (e.g., the portion of the preoperative images). In block 716, the portion of the recorded anatomical images is registered with the real-time images, and both are concurrently displayed on the portable video display device. The overlay may include, e.g., coronary arteries not readily visible upon a real-time image of a beating heart. Other features from the anatomical images may be overlaid onto the real-time images for display on the portable video display device as well.

In block 720, motion is compensated for an anatomical feature being imaged. The motion may include movement of the portable video display device, movement of the anatomical feature, etc. In block 722, the anatomical feature may include a beating heart, and motion of the beating heart is tracked to adjust the portion of the anatomical images (e.g., overlay image). In block 724, the anatomical feature may be tracked using a homography matrix H. The homography matrix H may be computed over time from a target anatomical feature in the anatomical feature being imaged. The matrix H is employed to deform the recorded anatomical images to maintain registration with the real-time images. In block 726, movement of the portable video display device is configured to concurrently change or track the real-time images and the overlay features as well. In this way, as the real-time images are changed the overlay image changes as well to provide accurate and relevant image data to assist a surgeon during a procedure. The procedure continues as needed and the images are updated accordingly in block 728.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for overlay and registration of preoperative data on live video using a portable device (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

1. A medical imaging system, comprising:
a computer device including a processor and a memory coupled to the processor, the memory storing:
recorded anatomical images of a subject; and
a registration module configured to: register features in pre-operative images; register features in real-time images with corresponding features in the preoperative images; and align the recorded anatomical images with the real-time images;
a portable video display device including a camera and a display screen, the portable video display device being configured to collect the real-time images of the subject to be registered with the recorded anatomical images of the subject such that at least a portion of the recorded anatomical images is concurrently displayed on the portable video display device registered with the real-time images; and
a communication link configured to permit communication and data transfer between the computer device and the portable video display device.

2. The system as recited in claim 1, wherein the portable video display device includes a smart phone or a tablet.

3. The system as recited in claim 1, wherein the registration module determines and tracks common points between the recorded anatomical images and the real-time video images.

4. The system as recited in claim 1, wherein the at least a portion of the recorded anatomical images includes an overlay concurrently displayed with the real-time video images.

5. The system as recited in claim 1, further comprising an image processing module configured to compensate for motion of at least one of: an anatomical feature being imaged and movement of the portable video display device.

6. The system as recited in claim 5, wherein the anatomical feature includes a beating heart and the at least a portion of the recorded anatomical images is adjusted to track motion of the beating heart.

7. The system as recited in claim 5, further comprising a homography matrix H computed over time from a target anatomical feature in the anatomical feature being imaged, wherein the matrix H is employed to deform the recorded anatomical images to maintain registration with the real-time images.

8. The system as recited in claim 1, wherein the recorded anatomical images include preoperative or intraoperative images collected using one or more imaging modalities.

9. The system as recited in claim 1, further comprising an image processing module configured to provide overlay features from the recorded anatomical images to be overlaid onto the real-time images for display on the portable video display device.

10. The system as recited in claim 9, wherein movement of the portable video display device changes the real-time images and the overlay features accordingly.

11. The system as recited in claim 1, further comprising an arm to secure a position of the portable video display device during a procedure.

12. A portable video display device for medical imaging, comprising:
a camera configured to collect real-time video;
a display screen configured to display the real-time video concurrently with overlay images registered with real-time images;
a processor; and
a memory coupled to the processor, the memory storing:
recorded anatomical images of a subject; and
a registration module configured to: register features in pre-operative images; register features in real-time images with corresponding features in the preoperative images; and align the recorded anatomical images with the real-time images;
wherein the overlay images include at least a portion of the stored anatomical images and are displayed on the portable video display device to assist a user in viewing anatomical features not readily observable.

13. The device as recited in claim 12, wherein the portable video display device includes a smart phone or a tablet.

14. The device as recited in claim 12, wherein the registration module determines and tracks common points between the recorded anatomical images and the real-time images.

15. The device as recited in claim 12, wherein the at least a portion of the recorded anatomical images includes hidden coronary arteries during open heart surgery.

16. The device as recited in claim 12, further comprising an image processing module configured to compensate for motion of at least one of: an anatomical feature being imaged and movement of the portable video display device.

17. The device as recited in claim 16, wherein the anatomical feature includes a beating heart and the at least a portion of the recorded anatomical images are adjusted to track motion of the beating heart.

18. The system as recited in claim 16, further comprising a homography matrix H computed over time from a target anatomical feature in the anatomical feature being imaged, wherein the matrix H is employed to deform the recorded anatomical images to maintain registration with the real-time images.

19. The device as recited in claim 16, wherein movement of the portable video display device changes the real-time images and the overlay images accordingly.

20. The device as recited in claim 12, wherein the recorded anatomical images include preoperative or intraoperative images collected using one or more imaging modalities.

21. A method for medical imaging, comprising:
storing anatomical images of a subject;
providing a portable video display device including a camera and a display screen, the portable video display device being configured to collect real-time images of the subject;
registering features in pre-operative images;
registering features in real-time images with corresponding features in the preoperative images;
registering at least a portion of the anatomical images with the real-time images; and
concurrently displaying on the portable video display the at least a portion of the anatomical images registered with the real-time images.

22. The method as recited in claim 21, wherein the portable video display device includes a smart phone or a tablet.

23. The method as recited in claim 21, wherein registering includes tracking common points between the anatomical images and the real-time images.

24. The method as recited in claim 21, further comprising generating an overlay from the at least a portion of the anatomical images; and overlaying features from the anatomical images onto the real-time images for display on the portable video display device.

25. The method as recited in claim 21, further comprising compensating for motion of at least one of: an anatomical feature being imaged and movement of the portable video display device.

26. The method as recited in claim 25, wherein the anatomical feature includes a beating heart and the method further comprises tracking motion of the beating heart to adjust the at least a portion of the anatomical images.

27. The method as recited in claim 25, wherein compensating for motion includes employing a homography matrix H computed over time from a target anatomical feature in the anatomical feature being imaged, wherein the matrix H is employed to deform the recorded anatomical images to maintain registration with the real-time images.

28. The method as recited in claim 25, wherein movement of the portable video display device changes the real-time images and the overlay features accordingly.

29. The method as recited in claim 21, wherein the anatomical images include preoperative or intraoperative images collected using one or more imaging modalities.
